(19) United States
(12) Patent Application Publication
(10) Pub. No.: US 2010/0327607 A1
(43) Pub. Date: Dec. 30, 2010

(54) APPARATUS FOR EXPELLING ENERGY AWAY FROM THE EARTH IN ORDER TO SUPPRESS GLOBAL WARMING

(75) Inventor: Kenji Kawai, Tokyo (JP)

Correspondence Address: BOYLE FREDRICKSON S.C., 840 North Plankinton Avenue, MILWAUKEE, WI, 53203, US

(73) Assignee: TUNER HOLDINGS KABUSHIKI KAISHA, Tokyo (JP)

(21) Appl. No.: 12/918,395

(22) PCT Filed: Feb. 10, 2009
(86) PCT No.: PCT/JP2009/052206

§ 371 Date: Aug. 19, 2010

(30) Foreign Application Priority Data
Feb. 19, 2008 (JP) 2008-036942

(51) Int. Cl. F03G 7/08; H02J 17/00

(52) U.S. Cl. 290/1 R

(57) ABSTRACT

An apparatus for expelling energy away from the earth in order to suppress global warming of the present invention is characterized by comprising a first generator for converting kinetic energy such as solar energy entering into atmosphere of the earth, geothermal energy, energy consumed by humans and converted mainly into heat or light, or a current of air or ocean waves etc. into electrical energy, a heat pump operated by the electrical energy obtained from the first generator, a second generator for converting heat energy produced by the heat pump into electrical energy, and an oscillator for converting the electrical energy obtained from the second generator into electromagnetic wave and radiating the electromagnetic wave into the outer space.

### BACKGROUND OF THE INVENTION

1. Field of the Invention

This invention relates to an apparatus for expelling energy away from the earth in order to suppress global warming, and more particularly relates to an apparatus for converting kinetic energy including heat energy in the atmosphere of the earth or on the earth into electromagnetic wave energy, and radiating the converted energy away from the earth in order to suppress global warming.

2. Description of the Related Art

As shown in FIG. 7, main energy entered into and absorbed by atmosphere 2 of the earth 1 per unit time comprises a solar energy 3 such as an electromagnetic wave energy etc. ejected from the sun and absorbed by the atmosphere 2 and the earth 1, a geothermal energy 4, and an energy 5 consumed by humans and converted mainly into heat. There is an electromagnetic wave energy etc. 6 ejected naturally from the earth 1 and the atmosphere 2 to the outer space. It is considered that the sum of the solar energy 3, the geothermal energy 4, and the energy 5 consumed by humans and converted mainly into heat is the same substantially with the electromagnetic wave energy etc. 6 ejected naturally to the outside of the atmosphere 2 of the earth 1 because the average temperature on the earth is not varied to a large extent from year to year.

However, recently there is a tendency of the global warming, because the solar energy 3 such as electromagnetic wave energy etc. ejected from the sun and absorbed by the atmosphere 2 and the earth 1, or the energy 5 consumed by humans and converted mainly into heat is increased, or the electromagnetic wave energy etc. 6 ejected naturally to the outside of the atmosphere 2 of the earth 1 is reduced by the increase of green house effect gas such as CO₂ etc. ejected from humans.

### SUMMARY OF THE INVENTION

Accordingly, in order to suppress global warming, in the present invention, kinetic energy including heat energy in the atmosphere of the earth or on the earth is converted into an electromagnetic wave energy, and the converted energy is ejected to the outside of the earth, or the converted energy is radiated from a region of high temperature to a region of low temperature. In other words, the converted energy is transmitted at a high speed as a radiation of light different from the transmission or circulation of heat, so that the consumption of energy for use in the cooler or heater in each region is reduced.

An apparatus for expelling energy away from the earth in order to suppress global warming according to the present invention is characterized by comprising a generator for converting kinetic energy such as solar energy entering into atmosphere of the earth, geothermal energy, energy consumed by humans and converted mainly into heat or light, or a current of air or ocean waves etc. into electrical energy, and an oscillator for converting the electrical energy obtained from the generator into electromagnetic wave and radiating the electromagnetic wave into the outer space.

Further, an apparatus for expelling energy away from the earth in order to suppress global warming according to the present invention is characterized by comprising a first generator for converting kinetic energy such as solar energy entering into atmosphere of the earth, geothermal energy, energy consumed by humans and converted mainly into heat or light, or a current of air or ocean waves etc. into electrical energy, a heat pump operated by the electrical energy obtained from the first generator, a second generator for converting heat energy produced by the heat pump into electrical energy, and an oscillator for converting the electrical energy obtained from the second generator into electromagnetic wave and radiating the electromagnetic wave into the outer space.

Further, it is characterized in that a wavelength range of the electromagnetic wave is a wavelength range so called as an atmospheric window.

Further, it is characterized in that a parabolic mirror is provided on the electromagnetic wave oscillator.

Further, it is characterized in that the electromagnetic wave is radiated from the ground surface into the outer space at such an angle that the electromagnetic wave is passed through an atmosphere on a region higher in latitude than a region on which the electromagnetic wave oscillator is positioned.

According to the apparatus for expelling energy away from the earth in order to suppress global warming of the present invention, the total of kinetic energy in the atmosphere of the earth or on the earth including heat, air current, ocean waves and the other energy is reduced, so that the heat energy on the earth can be reduced.

Further, the increase of the temperature in summer can be suppressed and the quantity of electrical power for the cooler can be reduced in summer, as a result that the global warming can be suppressed.

Further, the temperature around the heat pump or the evaporator thereof can be lowered by the cooling effect of the evaporator of the heat pump used in the cooler or the like.

Further, the electromagnetic wave is radiated into the outer space normally from the ground surface on which the electromagnetic wave oscillator is positioned, so that the path of the radiated electromagnetic wave in the atmosphere of the earth can be shortened, that the absorbing quantity of the radiated electromagnetic wave in the atmosphere of the earth can be minimized, and that the electromagnetic wave can be ejected to the outside of the earth more effectively.

Further, the electromagnetic wave is radiated from the ground surface into the outer space at such an angle that the electromagnetic wave is passed through an atmosphere on a region higher in latitude than a region on which the electromagnetic wave oscillator is positioned. Accordingly, the converted energy is transmitted at a high speed as a radiation of light different from the transmission or circulation of heat, so that the elevation of the temperature at a region of high latitude and low temperature or the consumption of energy for sue in the heater in this region is reduced, and as a result that the global warming can be suppressed. Further, the distribution of heat energy on the earth can be uniformed and accordingly the power of the typhoon etc. generated by the temperature difference at the regions different in latitude from one another can be reduced.

Further, the distribution of heat energy on the earth can be uniformed and the power of the typhoon etc. generated by the temperature difference at the regions different in latitude form one another can be reduced, by arranging the oscillators at regions centering around a region of high temperature.

### BRIEF DESCRIPTION OF THE DRAWINGS

FIG. 1 is an explanatory view of a first embodiment of an apparatus for expelling energy away from the earth in order to suppress global warming according to the present invention.

FIG. 2 is an explanatory view of a first embodiment of an apparatus for expelling energy away from the earth in order to suppress global warming according to the present invention.

FIG. 3 is a view showing a relation between the wavelength of the electromagnetic wave and the permeability of electromagnetic wave in the atmosphere.

FIG. 4 is an explanatory view of a first embodiment of an apparatus for expelling energy away from the earth in order to suppress global warming according to the present invention.

FIG. 5 is an explanatory view of a first embodiment of an apparatus for expelling energy away from the earth in order to suppress global warming according to the present invention.

FIG. 6 is an explanatory view of a second embodiment of an apparatus for expelling energy away from the earth in order to suppress global warming according to the present invention.

FIG. 7 is an explanatory view of energy entered into atmosphere of the earth, absorbed by the atmosphere, and ejected from the atmosphere per unit time.

### REFERENCE CHARACTERS

1 earth
2 atmosphere of earth
3 solar energy
4 geothermal energy
5 energy
6 energy etc.
7 generator
8 convertor
9 electromagnetic wave oscillator
10 parabolic mirror
11 first generator
12 heat pump
13 radiator
14 second generator
15 expansion valve
16 evaporator
17 compressor
18 equator
19 autorotation axis

### DETAILED DESCRIPTION OF THE PREFERRED EMBODIMENTS

Embodiments of the present invention will now be explained with reference to the drawings.

### Embodiment 1

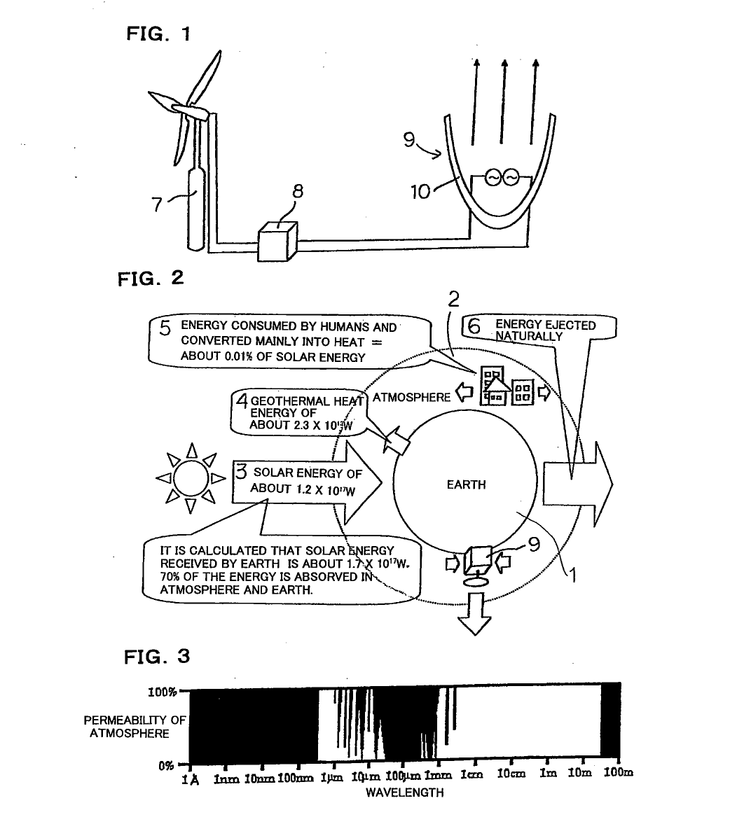

An apparatus for expelling energy away from the earth in order to suppress global warming according to the present invention, as shown in FIG. 1 and FIG. 2, comprises a generator 7 such as a solar light generator, a wind power generator, a wave activated power generator or a geothermal generator etc. for converting an excess energy which is not utilized for the human life in quality or in quantitative, and to be deleted, for example, in the energy (it is called as kinetic energy in the atmosphere of the earth or on the earth, hereinafter) such as a solar energy 3 entering into atmosphere 2 of the earth 1, a geothermal energy 4, an energy 5 consumed by humans and converted mainly into heat or light, or a current of air or ocean waves etc. into electrical energy, a convertor 8 for converting an alternative current generated by the generator into a direct current, and an electromagnetic wave oscillator 9 for converting the converted direct current into an electromagnetic wave, and ejecting the electromagnetic wave to the outside of the earth.

Further, an LED for converting the direct current into visible light etc. or a microwave oscillator for converting the direct current into microwave etc. can be used as the electromagnetic wave oscillator 9.

Further, a parabolic mirror 10 is provided on the electromagnetic wave oscillator 9, so that the dispersion of the electromagnetic wave ejected from the electromagnetic wave oscillator 9 is reduced and that the electromagnetic wave can be ejected effectively to the outer space.

Further, the electromagnetic wave is radiated into the outer space normally from the ground surface on which the electromagnetic wave oscillator is positioned, so that the absorption of the electromagnetic wave to be reached to the outer space in the atmosphere is minimized.

FIG. 3 shows a graph showing a relation between the wave-length of the electromagnetic wave and the permeability of electromagnetic wave in the atmosphere. Regions of wavelengths of 0.2-1.2 μm, 1.6-1.8 μm, 2-2.5 μm, 3.4-4.2 μm, 4.4-5.5 μm, 8-14 μm, and 1 cm-10 m etc. are called as “atmospheric window” wherein the permeability of electromagnetic wave in the atmosphere is high. It is preferable that the electromagnetic waves converted by the electromagnetic wave oscillator 9 are in said wavelength regions, and that the electromagnetic wave is in the ISM band and a wavelength band of 12 cm (frequency band of 2, 4 GHz) which is a candidate of use in the space solar light generation system.

According to the apparatus for expelling energy away from the earth in order to suppress global warming of the present invention, 12% of the kinetic energy in the atmosphere of the earth or on the earth received by the generator 7 can be ejected away from the earth, so that the total of the kinetic energy (heat, air current, sea wave or the other energy) in the atmosphere of the earth or on the earth can be reduced, and thus the heat energy on the earth can be reduced, because the energy Eₒᵤₜ ejected away from the earth can be expressed as Eₒᵤₜ=kinetic energy Eᵢₙ in the atmosphere of the earth or on the earth received by the generator 7×generating efficiency×electromagnetic wave ejecting efficiency×permeability of atmosphere=Eᵢₙ×0.12, where the generating efficiency of the generator 7 is 0.16, the electromagnetic wave ejecting efficiency converted into the micro wave from the electric energy and ejected away from the earth is 0.75 under the theoretical value of the space solar light generation system, and the permeability of the electromagnetic wave in the atmosphere is 0.98.

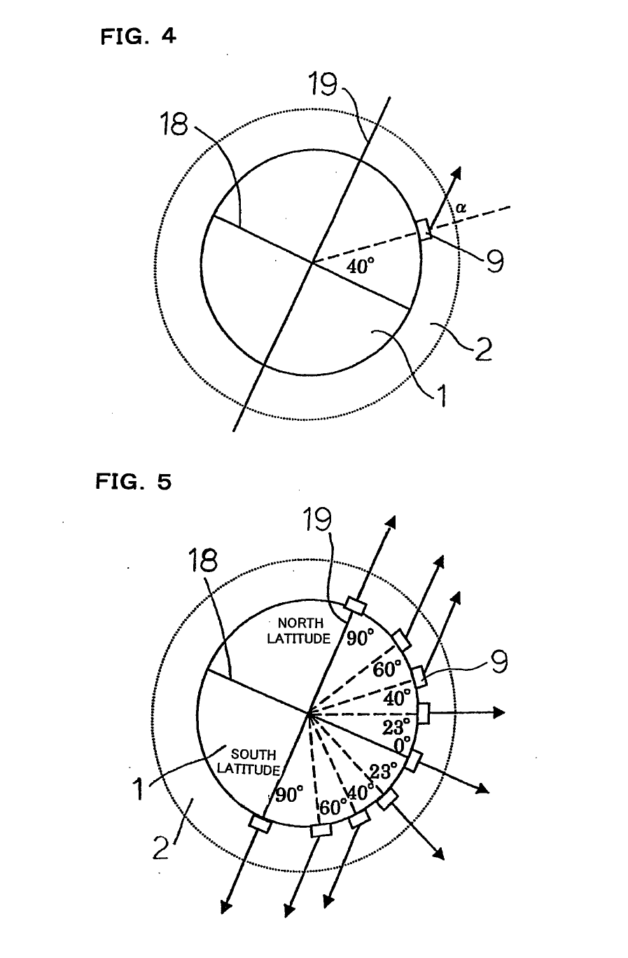

As shown in FIG. 4, the electromagnetic wave is radiated into the outer space not normally with respect to the ground surface of the earth but at such an angle α that the electromagnetic wave is passed through an atmosphere on a region higher in latitude and lower in temperature than a region on which the electromagnetic wave oscillator 9 is positioned. Further, the energy may be transmitted into the outer space at a high speed as a radiation of light different from the transmission or circulation of heat. FIG. 5 shows such an embodiment that a plurality of electromagnetic wave oscillators 9 for ejecting energy away from the earth are arranged at regions different in latitude from one another. In FIG. 5, a reference numeral 18 denotes the equator and a reference numeral 19 denotes an autorotation axis of the earth.

In case that the energy is ejected to a rejoin high in latitude and low in temperature, the elevation in temperature of the rejoin on which the electromagnetic wave oscillator 9 is positioned can be suppressed and accordingly the consumption of energy for use in the heater at this rejoin can be reduced, so that the global warming can be suppressed. Further, the distribution of the heat energy on the earth can be equalized, and accordingly the power such as the typhoon etc. generated by the temperature difference of the different latitude regions can be reduced.

Further, in case that a plurality of the apparatus for expelling energy away from the earth in order to suppress global warming of the present invention are used, it is preferable to set such a rule for each ejection angle of each electromagnetic wave ejected from each apparatus for expelling energy away from the earth with respect to the ground surface on which each apparatus is arranged that the electromagnetic waves ejected from the apparatus are parallel with one another or directed so as not to focus with one another in order to prevent the plurality of electromagnetic waves from being focused and caused a fire etc.

Further, it is considered that the ejection angle of the electromagnetic wave may be varied according to the season or time, however, it is difficult to vary at the same time all of the ejection angles of the electromagnetic waves. Accordingly, it is preferable to set the ejection angle of the electromagnetic wave to a value and not varied the value, in order to prevent a plurality of the electromagnetic waves from being focused and caused a fire, and the cost becoming high.

It may be set that the ejection angles of the electromagnetic waves are the same with respect to regions of predetermined latitudes or country.

Further, it is preferable to arrange the apparatus of the present invention centering around a region low in latitude and high in temperature, so that the temperature of rejoins around the apparatus can be lowered, the temperature difference between the near place of the equator and the near place of the north pole or the south pole is reduced, and thus it is expected to reduce the power of the typhoon etc.

Further, it is preferable that the apparatus of the present invention provided in the region relatively high in latitude is not operated in the winter season in order to prevent the temperature from being lowered extremely.

### Embodiment 2

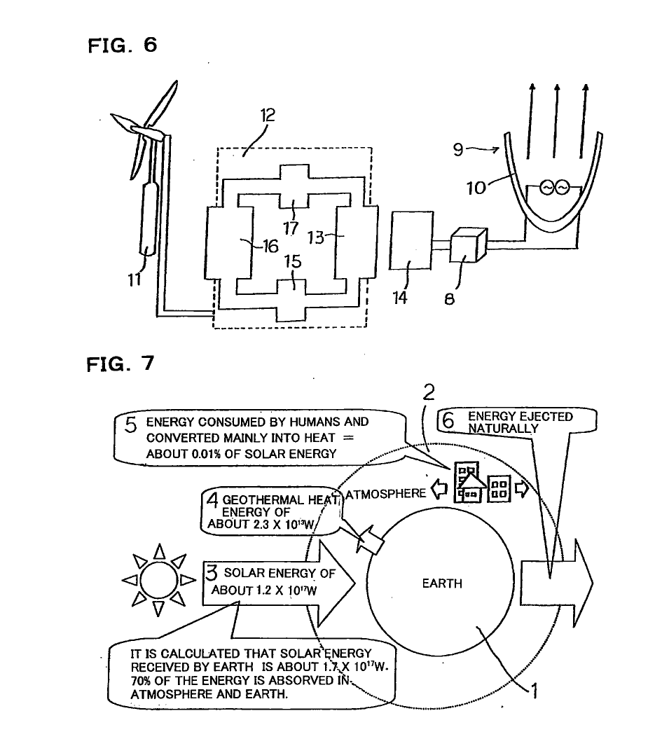

A second embodiment of an apparatus for expelling energy away from the earth in order to suppress global warming according to the present invention, as shown in FIG. 6, comprises a first generator 11 such as a solar light generator, a wind power generator, a wave activated power generator or a geothermal generator etc. for converting an excess energy which is not utilized for the human life in quality or in quantitative, and to be deleted, for example, in the energy (it is called as kinetic energy in the atmosphere of the earth or on the earth, hereinafter) such as a solar energy 3 entering into atmosphere 2 of the earth 1, a geothermal energy 4, an energy 5 consumed by humans and converted mainly into heat or light, or a current of air or ocean waves etc. into electrical energy, a heat pump 12 operated by the electrical energy obtained from the first generator 11, a second generator 14 such as a turbine generator for converting heat energy produced by a radiator (condenser) 13 of the heat pump 12 into electrical energy, a convertor 8 for converting an alternative current generated by the second generator 14 into a direct current, and an electromagnetic wave oscillator 9 for converting the converted direct current into an electromagnetic wave, and ejecting the electromagnetic wave to the outside of the earth.

In FIG. 6, a reference numeral 15 denotes an expansion valve, 16 denotes an evaporator and 17 denotes a compressor.

Further, an LED for converting the direct current into visible light etc. or a microwave oscillator for converting the direct current into microwave etc. can be used as the electromagnetic wave oscillator 9, as like as the embodiment 1.

Further, a parabolic mirror 10 is provided on the electromagnetic wave oscillator 9, so that the dispersion of the electromagnetic wave ejected from the electromagnetic wave oscillator 9 is reduced and that the electromagnetic wave can be ejected effectively to the outer space.

Further, the electromagnetic wave is radiated into the outer space normally from the ground surface on which the electromagnetic wave oscillator is positioned, so that the absorption of the electromagnetic wave to be reached to the outer space in the atmosphere is minimized.

Further, regions of wavelengths of 0.2-1.2 μm, 1.6-1.8 μm, 2-2.5 μm, 3.4-4.2 μm, 4.4-5.5 μm, 8-14 μm, and 1 cm-10 m etc. are so called as “atmospheric window” wherein the permeability of electromagnetic wave in the atmosphere is high. It is preferable that the electromagnetic waves converted by the electromagnetic wave oscillator 9 are in said wavelength regions, and that the electromagnetic wave is in the ISM band and a wavelength band of 12 cm (frequency band of 2, 4 GHz) which is a candidate of use in the space solar light generation system.

According to the apparatus for expelling energy away from the earth in order to suppress global warming in the second embodiment of the present invention, 11% of the kinetic energy in the atmosphere of the earth or on the earth received by the first generator can be ejected away from the earth, so that the total of the kinetic energy (heat, air current, sea wave or the other energy) in the atmosphere of the earth or on the earth can be reduced, and thus the heat energy on the earth can be reduced, because the energy Eₒᵤₜ ejected away from the earth can be expressed as Eₒᵤₜ=kinetic energy Eᵢₙ in the atmosphere of the earth or on the earth received by the first generator×generating efficiency of the first generator×heat pump efficiency×generating efficiency of the second generator×electromagnetic wave ejecting efficiency×permeability of atmosphere=E×0.11, where each generating efficiency of the first and second generators 11 and 14 is 0.16, the electromagnetic wave ejecting efficiency converted into the micro wave from the electric energy and ejected away from the earth is 0.75 under the theoretical value of the space solar light generation system, and the permeability of the electromagnetic wave in the atmosphere is 0.98.

Further, the temperature around the evaporator 16 of the heat pump 12 can be reduced by the cooling effect of the evaporator 16 of the heat pump 12.

The electromagnetic wave may be radiated into the outer space not normally with respect to the ground surface of the earth but at such an angle α that the electromagnetic wave is passed through an atmosphere on a region higher in latitude and lower in temperature than a region on which the electromagnetic wave oscillator 9 is positioned. Further, the energy may be transmitted into the outer space at a high speed as a radiation of light different from the transmission or circulation of heat.

In case that the energy is ejected to a rejoin high in latitude and low in temperature, the elevation in temperature of the rejoin on which the electromagnetic wave oscillator 9 is positioned can be suppressed and accordingly the consumption of energy for use in the heater at this rejoin can be reduced, so that the global warming can be suppressed. Further, the distribution of the heat energy on the earth can be equalized, and accordingly the power such as the typhoon etc. generated by the temperature difference of the different latitude regions can be reduced.

We claim:

1. An apparatus for expelling energy away from the earth in order to suppress global warming, comprising: a generator for converting kinetic energy such as solar energy entering into atmosphere of the earth, geothermal energy, energy consumed by humans and converted into heat or light, an air current, or ocean waves into electrical energy, and an oscillator for converting the electrical energy obtained from the generator into electromagnetic wave and radiating the electromagnetic wave into the outer space.

2. An apparatus for expelling energy away from the earth in order to suppress global warming, comprising: a first generator for converting kinetic energy such as solar energy entering into atmosphere of the earth, geothermal energy, energy consumed by humans and converted into heat or light, an air current, or ocean waves into electrical energy, a heat pump operated by the electrical energy obtained from the first generator, a second generator for converting heat energy produced by the heat pump into electrical energy, and an oscillator for converting the electrical energy obtained from the second generator into electromagnetic wave and radiating the electromagnetic wave into the outer space.

3. The apparatus as claimed in claim 1, wherein a wavelength range of the electromagnetic wave is a wavelength range so called as an atmospheric window.

4. The apparatus as claimed in claim 1, wherein a parabolic minor is provided on the electromagnetic wave oscillator.

5. The apparatus as claimed in claim 1, wherein the electromagnetic wave is radiated into the outer space normally from the ground surface on which the electromagnetic wave oscillator is positioned.

6. The apparatus as claimed in claim 1, wherein the electromagnetic wave is radiated from the ground surface into the outer space at angle at which the electromagnetic wave is passed through an atmosphere on a region higher in latitude than a region on which the electromagnetic wave oscillator is positioned.

7. The apparatus as claimed in claim 2, wherein a wavelength range of the electromagnetic wave is a wavelength range so called as an atmospheric window.

8. The apparatus as claimed in claim 2, wherein a parabolic minor is provided on the electromagnetic wave oscillator.

9. The apparatus as claimed in claim 2, wherein the electromagnetic wave is radiated into the outer space normally from the ground surface on which the electromagnetic wave oscillator is positioned.

10. The apparatus as claimed in claim 2, wherein the electromagnetic wave is radiated from the ground surface into the outer space at an angle at which the electromagnetic wave is passed through an atmosphere on a region higher in latitude than a region on which the electromagnetic wave oscillator is positioned.

11. An apparatus for expelling energy away from the earth in order to suppress global warming, comprising: a generator for converting kinetic energy into electrical energy, and an oscillator that at least indirectly receives electrical energy from the generator, that converts the received electrical energy into an electromagnetic wave, and that radiates the electromagnetic wave into the outer space.

12. The apparatus as claimed in claim 11, wherein the kinetic energy comprises at least one of solar energy entering into the atmosphere of the earth, geothermal energy, energy consumed by humans and converted into heat or light, an air current, and ocean waves.

13. The apparatus as claimed in claim 11, wherein the generator is a first generator, and further comprising a heat pump that is operated by the electrical energy obtained from the first generator and that produces heat energy, and a second generator that coverts the heat energy produced by the heat pump into electrical energy and that provides electrical energy to the oscillator.

14. The apparatus as claimed in claim 11, wherein a wavelength range of the electromagnetic wave as an atmospheric window.

15. The apparatus as claimed in claim 11, further comprising parabolic mirror provided on the electromagnetic wave oscillator.

16. The apparatus as claimed in claim 11, wherein the electromagnetic wave is radiated into the outer space normally from a ground surface on which the electromagnetic wave oscillator is positioned.

17. The apparatus as claimed in claim 11, wherein the electromagnetic wave is radiated from a ground surface into the outer space at an angle at which the electromagnetic wave is passed through an atmosphere on a region higher in latitude than a region on which the electromagnetic wave oscillator is positioned.
